(19) United States
(12) Patent Application Publication
(10) Pub. No.: US 2026/0332068 A1
(43) Pub. Date: Oct. 22, 2026

(54) APPARATUS AND METHOD FOR ESTIMATING CURRENT DELAY COMPONENT, AND VEHICLE CONTROL SYSTEM INCLUDING THE SAME

(71) Applicant: HL MANDO CORPORATION, Gyeonggi-do (KR)

(72) Inventor: Yunjai OH, Gyeonggi-do (KR)

(21) Appl. No.: 19/529,088

(22) Filed: Feb. 3, 2026

(30) Foreign Application Priority Data
Mar. 19, 2025 (KR) 10-2025-0035147
Sep. 24, 2025 (KR) 10-2025-0137778

(51) Int. Cl. H02P 6/15; B62D 5/04

(52) U.S. Cl. CPC H02P 6/153; B62D 5/046; B62D 5/0487

(57) ABSTRACT

An apparatus and a method for estimating a current delay component may set a current delay correction variable for correcting an inconsistency between a current sampling timing and a rotor position detection timing; acquire torque response data based on the current delay correction variable by driving the motor under a previously set current application condition; estimate a current delay component based on the current delay correction variable and the torque response data; and control the motor based on the current delay component estimated based on the current delay correction variable and the torque response data.

### CROSS-REFERENCE TO RELATED APPLICATIONS

This application claims the priority of Korean Patent Application Nos. 10-2025-0035147 and 10-2025-0137778 filed on Mar. 19, 2025 and Sep. 24, 2025, respectively, in the Korean Intellectual Property Office, the disclosure of which is incorporated herein by reference in their entireties.

### BACKGROUND

### Field

The present exemplary embodiments relate to an apparatus and a method for estimating a current delay component.

### Description of the Related Art

Electric motors are used as key power sources in various industrial equipment and vehicle drive systems and precise control technique is recognized as an important factor which determines a performance and stability of the system. During the control process of the electric motor, a torque is generated based on a rotor position detection signal and a current sensor signal. At this time, if a measurement timing and a control operation timing do not match, a desired torque output is not accurately reproduced. The inconsistency between the timings is generally caused by the difference between the current sampling timing and the rotor position sampling timing and in particular, if the electric motor rotates at a high speed or a sharp load fluctuation occurs, the response characteristic of the controller is directly affected. Consequently, the torque linearity is degraded and unnecessary vibration or noise is generated to deteriorate the reliability of the entire driving system.

Generally, in order to reduce the delay phenomenon, precision of the sensor is improved or a control operation period is shortened. Further, a compensation technique which applies a phase compensation filter or utilizes a model-based estimated value has been proposed. However, according to this approach, a control algorithm becomes complex or the approach is applied only in a specific rotation speed section so that it is not easy to comprehensively respond various operation conditions. Therefore, a technique for stably and reliably processing the delay component is consistently demanded.

In the meantime, in the field where the safety is important, such as a vehicle control system, a fine control error may directly affect the driving stability and the ride comfort so that a technique for precisely handling the delay component and ensuring a consistent control performance in various driving conditions is demanded.

### SUMMARY

With this background, an object of the present disclosure is to provide an apparatus and a method for estimating a current delay component.

In order to achieve the above-described object, according to an aspect, the present disclosure may provide an apparatus for controlling a motor. An apparatus includes memory configured to store instructions and at least one processor configured to execute one or more of the instructions to perform operations comprising: setting a current delay correction variable for correcting an inconsistency between a current sampling timing and a rotor position detection timing, acquiring torque response data based on the current delay correction variable by driving the motor under a previously set current application condition, estimating a current delay component based on the current delay correction variable and the torque response data and controlling the motor based on the current delay component estimated based on the current delay correction variable and the torque response data.

According to another aspect, the present disclosure provides a method for controlling a motor, the method comprising setting a current delay correction variable for correcting an inconsistency between a current sampling timing and a rotor position detection timing, acquiring torque response data based on the current delay correction variable by driving the motor under a previously set current application condition, estimating a current delay component based on the current delay correction variable and the torque response data and controlling the motor based on the current delay component estimated based on the current delay correction variable and the torque response data.

According to still another aspect, the present disclosure provides a vehicle control system including a steering controller configured to control steering of a vehicle, a motor configured to generate a steering torque for an operatio associated with the steering of the vehicle and at least one processor configured to: set a current delay correction variable for correcting an inconsistency between a current sampling timing and a rotor position detection timing, acquiring torque response data based on the current delay correction variable by driving the motor under a previously set current application condition, estimating a current delay component based on the current delay correction variable and the torque response data and controlling the motor based on the current delay component estimated based on the current delay correction variable and the torque response data.

According to the present exemplary embodiments, an apparatus, a method, and a system for controlling a motor based on a current delay component which corrects inconsistency between the current sampling timing and the rotor position detection timing can be provided.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram of an exemplary computing system which is used for the present disclosure;

FIG. 2 is an exemplary flowchart illustrating a current delay component estimation process according to an exemplary embodiment of the present disclosure;

FIG. 3 is an exemplary view for explaining a current delay correction variable and a current delay component according to an exemplary embodiment of the present disclosure;

FIG. 4 is an exemplary flowchart illustrating a process of estimating a current delay component based on a relationship between a current delay correction variable and torque response data according to an exemplary embodiment of the present disclosure;

FIG. 5 is an exemplary flowchart illustrating a current delay component estimation process according to an exemplary embodiment of the present disclosure from which delay due to a friction torque is excluded;

FIG. 6 is an exemplary flowchart illustrating a current delay component estimation process according to an exemplary embodiment of the present disclosure from which delay due to an offset error is excluded; and

FIG. 7 is an exemplary flowchart illustrating a current delay component estimation method according to an exemplary embodiment of the present disclosure.

### DETAILED DESCRIPTION OF THE EMBODIMENT

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

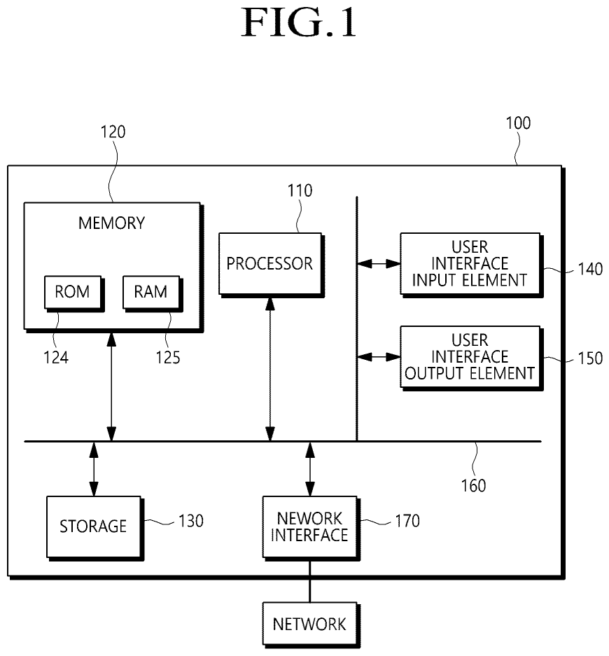

FIG. 1 is a block diagram of an exemplary computing system which is used for the present disclosure.

Referring to FIG. 1, a computer system 100 reflects a hardware configuration of a current delay component estimation apparatus and includes one or more processors 110, a memory 120, a storage 130, a user interface input element 140, a user interface output element 150, a bus 160, and a network interface 170.

The processor 110 may be a central processing unit (CPU) or a semiconductor device which performs other computation functions. The processor 110 executes an instruction stored in the memory 120 and/or the storage 130 to perform a computation, such as setting of a current delay correction variable for correcting inconsistency between the current sampling timing and the rotor position detection timing, acquisition of torque response data, estimation of a current delay component, and generation of a delay compensation control signal.

The memory 120 may include a volatile memory and a non-volatile memory and for example, include a read only memory (ROM) 124 and a random access memory (RAM) 125. The ROM 124 may store a basic parameter and an initial setting value of the current delay component estimation algorithm and the RAM 125 stores temporary data, such as sampling data, torque response data, a regression operation median value received from the electric motor.

The storage 130 may include various non-volatile storage media, such as hard disk driver (HDD), solid state drive (SSD), or embedded multi media card (eMMC). For example, the storage 130 stores a delay component estimation history, a correction result record, a sensor parameter, and a diagnosis log.

The user interface input element 140 is a component for receiving a system setting, diagnosis, and user's instruction and may include a touch screen, a button switch, and an external input terminal. The user interface output element 150 is a component for displaying a current delay component estimation result, a correction state, and a diagnosis message and may be implemented by a display, an LED, and an alarm module.

The bus 160 is an internal data path for transmitting and receiving data between the components and allows the components to organically interwork with each other.

Further, the computer system 100 may include a network interface 170 for interconnection with an in-vehicle CAN communication network or other vehicle network and may perform a communication function for data exchange with an external electronic control unit (ECU), remote diagnosis, or correction instruction reception.

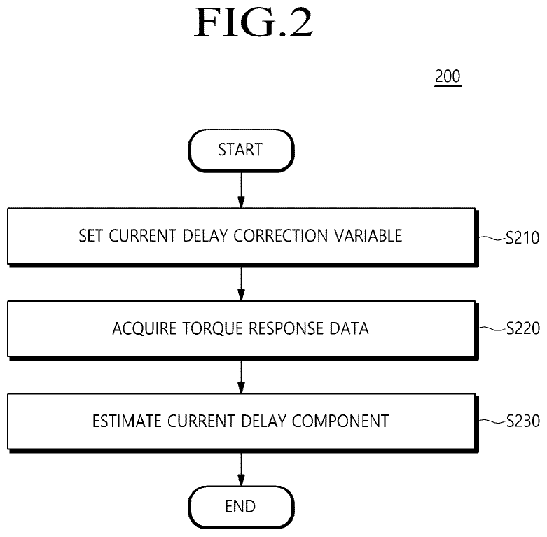

According to an exemplary embodiment of the present disclosure, the current delay component estimation apparatus precisely estimates and corrects a delay component due to inconsistency between the current sampling timing and the rotor position detection timing to provide a stable control performance even in various operation conditions. A specific configuration and an operation procedure of the current delay component estimation apparatus according to the present disclosure will be described below with reference to FIGS. 2 to 6.

In the present disclosure, an example that the current delay component estimation apparatus is implemented as a separate component provided in the vehicle system will be mainly described, but it is not limited thereto. For example, the current delay component estimation apparatus may be included and implemented in an electronic control unit (ECU), an electric power steering (EPS) controller, a steer-by-wire (SbW) controller, or a chassis integrated controller and the delay estimation and compensation function of the present disclosure may be operated in one integrated ECU together with other motor control function.

Further, the current delay component estimation apparatus may interwork with other control device in the vehicle system, for example, a vehicle central controller or a gate driver control module or may be mounted in the corresponding configuration. An implementation form of the current delay component estimation apparatus may be diversely selected according to a vehicle electronic system architecture and an operating environment in various manners and the technical spirit of the present disclosure may be applied to various structures in the same way.

The computing system according to the present disclosure may be connected to a server system. For example, the server system is connected to the computing system according to the present disclosure through a network in a wired or wireless manner to transmit or receive data and share a computing resource.

For example, the server system may be constructed as a cloud system. For example, the server system may include a configuration which allows an individual computing device to be connected to a server system via a network and allows the connected computing device to share the computing resource. In this case, the individual computing device may access the cloud system in any place in the environment which is connected to a network, such as Internet.

For example, the cloud system flexibly expands or reduces the computing resource as needed and shares the computing resource with the other computing device connected through a network. Further, the cloud system may be constructed based on various service models, such as infrastructure as a service (IaaS), platform as a service (Paas), or software as a service (SaaS) depending on a usage purpose or range.

For example, the cloud system may include at least one or more computing devices, storage devices, and network devices. Each computing device included in the cloud system may include a processor and a memory to process various computing tasks. The storage device may include a configuration related to the data storage, such as a hard disk drive (HDD), a solid state drive (SSD), a network attached storage (NAS), or a storage area network (SAN), to store massive data. The network device may include a networking related configuration, such as a switch, a router, a load distribution device, and a firewall.

For example, in order to perform various computations or data classification and generation tasks using an artificial intelligence model, the computing system may use an artificial intelligence model stored in a memory of the computing system.

Alternatively, in some cases, the computing system may share the computing resource with the cloud system to use an artificial intelligence model stored in the cloud system. In this case, even though the computing system itself does not directly possess a configuration related to the artificial intelligence model, the computing system may process related tasks using an artificial intelligence model provided from the cloud system.

The processes, systems and methods described herein can be implemented by the computing system in response to the processor executing an arrangement of instructions contained in main memory. Such instructions can be read into main memory from another computer-readable medium, such as the storage device. Execution of the arrangement of instructions contained in main memory causes the computing system to perform the illustrative processes described herein. One or more processors in a multiprocessing arrangement may also be employed to execute the instructions contained in main memory. Hard-wired circuitry can be used in place of or in combination with software instructions together with the systems and methods described herein. Systems and methods described herein are not limited to any specific combination of hardware circuitry and software.

Although an example computing system has been described, the subject matter including the operations described in this specification can be implemented in other types of digital electronic circuitry, or in computer software, firmware, or hardware, including the structures disclosed in this specification and their structural equivalents, or in combinations of one or more of them.

Hereinafter, specific operation procedures of setting a current delay correction variable, acquiring a torque response data set, and estimating a current delay component which are performed by a processor of the current delay component estimation apparatus according to the present disclosure will be described in detail with reference to FIGS. 2 to 5.

FIG. 2 is an exemplary flowchart illustrating a current delay component estimation process 200 according to an exemplary embodiment of the present disclosure.

According to an exemplary embodiment of the present disclosure, the processor may set a current delay correction variable for correcting the inconsistency between the current sampling timing and the rotor position detection timing (S210).

According to the exemplary embodiment, the current delay correction variable may be set to a plurality of different values within a previously defined range, based on a time unit corresponding to the sampling period. The current delay correction variable may be defined as a reference value for numerically correcting a temporal delay which may occur during a sampling process so as to correspond to torque response data according to a driving state of the electric motor. The current delay correction variable is not limited to a single value, but may be set to a plurality of candidate values. The response characteristic of the electric motor according to various operation conditions can be compared and analyzed by means of a current delay correction variable which is set to the plurality of candidate values, thereby estimating a current delay component.

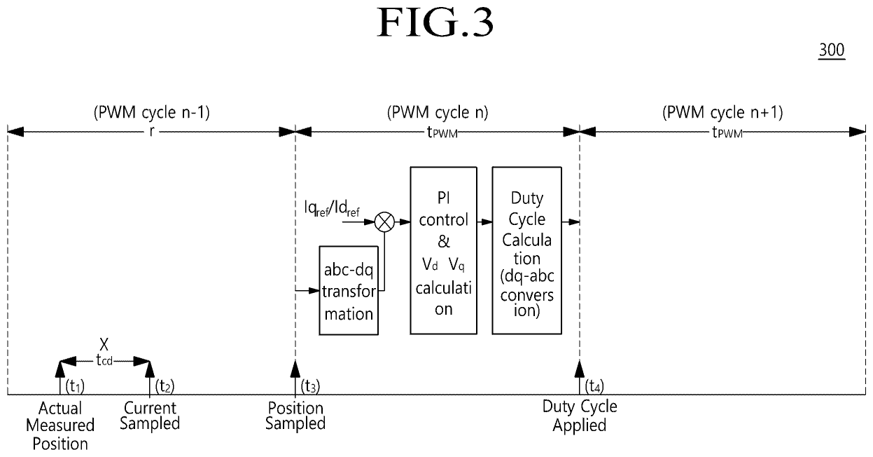

FIG. 3 is an exemplary view 300 for explaining a current delay correction variable and a current delay component according to an exemplary embodiment of the present disclosure.

Referring to FIG. 3, the electric motor is driven in the unit of PWM cycle and current and position information sampling, transformation, control computation, and duty cycle application are performed at every cycle. As illustrated in FIG. 3, the rotor position is measured at a timing t1 and a current is sampled at a timing t2. However, during an actual measurement process, temporal inconsistency occurs between two timings due to the difference in sensor signal processing and sampling timing and such a difference may be a current delay component t_{cd}. The current delay component is reflected as a position error θ_{cd} in proportion to the rotor speed and specifically, the control performance may be degraded under a high-speed operation.

For example, the current sampling result is input to an abc-dq converter to be transformed into a d-q axis current and PI control and a voltage command (V_{d}, V_{q}) computation may be performed. Further, the duty cycle is determined by means of dq-abc inverse conversion and a duty cycle is actually applied to an inverter switching element at a timing t4. Here, the timing t3 is a reference timing to which position sampling is reflected to be used for control computation and at the timing t3, position detection information is put to the computation path after the current sampling t2. At the timing t3, the current and the rotor position information are input to the controller together to fully perform d-q conversion and PI control computation. Accordingly, as the actual electric motor control operation, the sensor signal acquisition, computation, and application steps are sequentially performed in each PWM cycle.

In the meantime, a current delay correction variable x is defined to numerically correct the inconsistency between the current sampling timing t2 and the position sampling timing t1. That is, in the present disclosure, the current delay correction variable x is set based on the difference between the position detection timing and the current sampling timing and is changed to a plurality of candidate values to match torque response data, thereby estimating the actual current delay component. That is, the current delay correction variable x may be utilized as a correction criterion for estimating a current delay component t_{cd} which cannot be directly measured.

According to the exemplary embodiment, the processor may sequentially set the current delay correction variable to a plurality of candidate values. Each candidate value of the current delay correction variable may be changed to increase or decrease based on a time unit defined in the sampling period. The processor divides one sampling period into a plurality of subdivided time sections and each section is allocated with a current delay correction variable. By doing this, the processor assumes the difference between the current sampling timing and the position detection timing in various ranges and compares and analyzes torque response data acquired under the assumed condition.

The current delay correction variable is not a simple estimation value, but may be set as a search parameter to reflect a delay deviation which may occur under an actual operation condition. That is, the current delay correction variable may be interpreted as a virtual correction value for modeling a complex time error caused by sensor signal processing delay, a response characteristic of the current detection circuit, asynchronous sampling effect of the PWM cycle. The torque response data obtained by applying a plurality of current delay correction variables by the processor may serve as a data set which reflects delay component distribution in an actual electric motor system.

According to the exemplary embodiment of the present disclosure, the processor may acquire torque response data according to a current delay correction variable so as to correspond to a driving state of the electric motor under a condition in which a previously set current is applied (S220).

The previously set current application condition may be a current application condition in which a q-axis current is maintained as 0 and only a d-axis current is applied. The condition in which the q-axis current is maintained as 0 is a condition in which a component which directly contributes to generation of a torque of the electric motor is excluded and only the d-axis current is applied to observe a pure torque response change according to the current delay component. In such a condition, the electric motor operates while minimizing a driving torque and the influence caused by the inconsistency between the current sampling timing and the rotor position detection timing may be directly reflected to the torque response data.

In one exemplary embodiment, the processor sets a q-axis current command to 0, generates a current control signal including only the d-axis current command to transmit the current control signal to the inverter, thereby controlling the electric motor to be driven according to a previously set current application condition. At this time, the inverter performs a switching operation based on a current control signal received from the processor to supply a d-axis current required for the electric motor, and consequently, the electric motor represents a response which reflects an influence of the delay component in a state in which torque generation is suppressed.

For example, if a torque change determined by a torque sensor or an estimation algorithm is recorded in a state in which the d-axis current is applied step by step and the q-axis current is fixed to 0, only the influence of the current delay component is reflected to the torque response at each step, thereby facilitating analysis. Further, this condition may contribute to separating data from an external load or an additional torque-generation factor to clearly distinguish the effects caused by the delay component.

Further, according to the exemplary embodiment, the d-axis current may be set based on one of a maximum current value of the inverter and a current source component value of a permanent magnet. Specifically, the d-axis current may be set based on a smaller value between the maximum current value of the inverter and the current source component value of a permanent magnet. To be more specific, the current source component value of the permanent magnet may be defined as an equivalent current corresponding to a value obtained by dividing a permanent magnet magnetic flux λf by a d-axis inductance Ld, which means a current limit value determined by a unique characteristic of the electric motor. Accordingly, the processor sets a d-axis current command based on a smaller value between a maximum current value which can be provided by the inverter and an equivalent current value based on a current source component of the permanent magnet to provide a sufficient stimulus signal required for estimation of the current delay component without departing from a stable driving range of the electric motor.

As described above, the d-axis current is set to a limited value so that the entry to the saturation region of the electric motor or damage due to the overcurrent may be prevented and the reliability of data for estimating a current delay component may be ensured as well.

For example, if the d-axis current is excessively set, magnetic flux saturation may be caused. The magnetic flux saturation non-linearly changes the torque response characteristic and a normal correlation between the current and the torque may be distorted. If the torque response characteristic is distorted, the determination result and the actual value do not match during the process of estimating the current delay component, which may result in the degradation of the estimation accuracy.

According to the present disclosure, the d-axis current is restricted based on the maximum current value of the inverter and the current source component value of the permanent magnet to prevent the distortion caused by the magnetic flux saturation. By doing this, the reliable correlation between the current delay correction variable and the torque response data is secured, thereby precisely determining the current delay component.

According to the exemplary embodiment, the processor changes the current delay correction variable to the plurality of candidate values and acquires a plurality of torque response data so as to correspond to the plurality of candidate values. For example, the torque response of the electric motor corresponding to each variable value may be measured while changing the current delay correction variable to 1, 2, 3, . . . , in the unit of sampling periods. Through this process, it is possible to compare how the response curve changes depending on the differences in the current delay correction variable under the same current application condition.

Further, the processor may generate a torque response data set by matching each of the plurality of torque response data and a corresponding current delay correction variable value. The torque response data set is configured by a set of pairs in which the current delay correction variable value and the torque value (that is, torque response data) match one to one and sequentially serves as a basis for applying linear regression or a calibration algorithm.

According to the exemplary embodiment of the present disclosure, the processor may estimate the current delay component based on the current delay correction variable and the torque response data (S230).

According to the exemplary embodiment, the current delay component is a temporal delay element caused due to the inconsistency of the current sampling timing and the rotor position detection timing and a magnitude thereof may vary according to a rotation speed and an operation condition of the electric motor.

In one exemplary embodiment, if the electric motor is driven under a previously set current application condition (in which a q-axis current is maintained at 0 and only the d-axis current is applied), torque response data which varies depending on the current delay correction variable value may be obtained. The processor matches the torque response data acquired under the set driving condition with the plurality of current delay correction variable values to configure a torque response data set and analyzes the torque response data set to determine the current delay component.

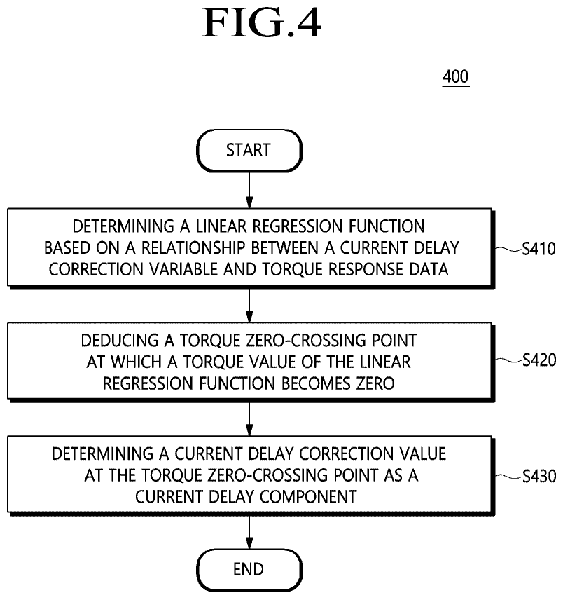

That is, the torque response change according to the change in the current delay correction variable value is cumulatively compared while repeatedly driving the electric motor under the same current application condition to estimate the current delay component. A specific estimation procedure of the current delay component will be described in detail with reference to FIG. 4.

FIG. 4 is an exemplary flowchart illustrating a process 400 of estimating a current delay component based on a relationship between a current delay correction variable and torque response data according to an exemplary embodiment of the present disclosure.

Referring to FIG. 4, determining a linear regression function based on a relationship between the current delay correction variable and the torque response data may be performed (S410).

Specifically, the processor approximates the change of the torque response corresponding to each current delay correction variable value to a linear or curved function, thereby numerically expressing the correlation between the variable and the response.

Further, deducing a torque zero-crossing point at which a torque value of the linear regression function becomes zero may be performed (S420). Since the current delay correction variable is a reference value which corrects an assumed inconsistency of the current sampling timing and the position detection timing, if it does not match the actual current delay component, torque response data may be biased to be positive (+) or negative (−). Therefore, a point where a sign of the torque response is switched, that is, a torque zero-crossing point may refer to a point where an assumed current delay correction variable and the actual current delay component match.

Further, Determining a current delay correction value at the torque zero-crossing point as a current delay component (S430). Specifically, the torque response data acquired by changing the current delay correction variable may substantially form a linear correlation and the linear correlation may be expressed by a function between a correction variable (x-axis) and a torque value (y-axis). A point where a straight line obtained by the linear regression function crosses the y-axis (torque value)=0 corresponds to a condition that the torque response is balanced and the x-axis value at the time, that is, the current delay correction variable may correspond to the actual current delay component t_{cd}. Accordingly, the processor may numerically estimate the current delay component which is not directly measured by utilizing an x-axis intercept of the linear regression function.

In summary, the processor drives the electric motor under a condition where a previously set current is applied and changes the current delay correction variable x to acquire torque response data thereby. The acquired torque response data is configured by a torque response data set representing correlation between the current delay correction variable and the torque response and the processor may determine the linear regression function based on the torque response data set. The linear regression function is a result of mathematically modeling how the torque response varies according to the correction variable change and the intercept where the function crosses the x-axis refers to a point corresponding to the current delay component t_{cd}. That is, the processor determines that the corresponding intercept value indicates the inconsistency between the actual current sampling timing and the rotor position detection timing to estimate an intercept value as a current delay component.

According to the exemplary embodiment of the present disclosure, the processor removes the friction torque from the torque response data acquired by driving the electric motor under the previously set current application condition to acquire friction-corrected torque response data. The torque response data excluding the friction torque is acquired to exclude unnecessary mechanical influence element during the current delay component estimation process and more precisely reflect the inconsistency between the current sampling timing and the rotor position detection timing.

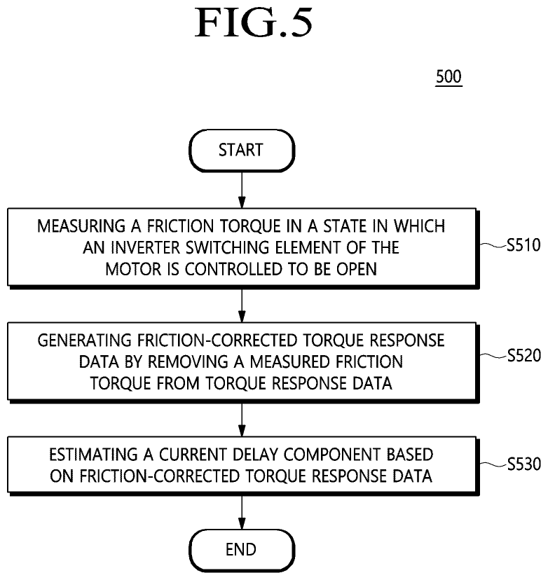

FIG. 5 is an exemplary flowchart illustrating a current delay component estimation process 500 according to an exemplary embodiment of the present disclosure from which delay due to a friction torque is excluded.

Referring to FIG. 5, measuring a friction torque in a state in which a switch of an inverter of the motor is controlled to be open (S510). To be more specific, the processor generates a control signal to open the inverter switching element to transmit the control signal to the gate driver to implement a state in which the inverter output is blocked. The state in which the switching element is open refers to a condition that the electric driving force by the inverter is not applied to the electric motor and in this case, the electric motor rotates or resists only by the mechanical load and an internal friction without having an external applied current. That is, a torque measured in a state in which the switching element is open may be a pure friction torque component generated in a state in which a current is not applied.

Further, generating friction-corrected torque response data by removing a measured friction torque from torque response data (S520). The friction torque may cause unnecessary influence during the current delay component estimation process. Therefore, the torque response data may reflect only the pure response according to the current delay correction variable by removing the measured friction torque.

Further, Estimating a current delay component based on friction-corrected torque response data (S530). The data from which the influence of the friction torque is removed may be applied to a zero-crossing analysis procedure based on the linear regression described with regard to FIG. 4, thereby more precisely and reliably estimating a current delay component. That is, the analysis is performed while excluding the friction factor, so that the processor more clearly identifies the inconsistency between the current sampling timing and the rotor position detection timing and more precisely determines the actual current delay component.

According to the exemplary embodiment of the present disclosure, the processor may perform the computation by considering both forward and backward driving to remove the influence caused by an offset error of the rotor position sensor during the current delay component estimation process. The current delay component determined during the forward driving and the backward driving may have symmetric deviations due to the offset error and the inconsistency due to the offset may be cancelled by averaging two values.

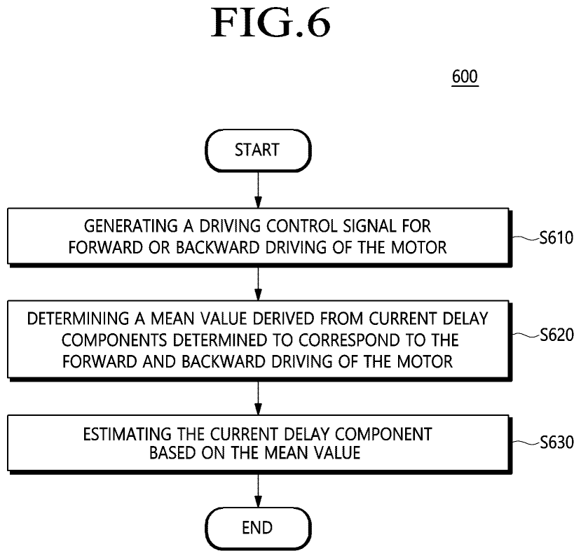

FIG. 6 is an exemplary flowchart illustrating a current delay component estimation process 600 according to an exemplary embodiment of the present disclosure from which delay due to an offset error is excluded.

To be more specific, referring to FIG. 6, generating a driving control signal for forward or backward driving of the motor (S610). According to the exemplary embodiment, the forward and backward driving of the electric motor may be performed under the previously set current application condition, as described with regard to FIG. 4.

According to the exemplary embodiment, the forward driving refers to a condition in which the rotor position sensor operates in a direction increasing from a reference angle and the backward driving may refer to a condition operating in a reverse direction. The rotor position sensor may include a constant regular deviation, that is, an offset error, between the actual position and the detected position, due to a physical installation error or a signal processing variation. Further, the offset error has a characteristic of being reflected with opposite signs in a forward direction and a backward direction.

Further, determining a mean value derived from current delay components determined to correspond to the forward and backward driving of the motor (S620). The current delay component in the forward direction is distorted to a positive (+) direction and the current delay component in the backward direction is distorted to a negative (−) direction so that if two results are averaged, the offset errors are cancelled, and only an actual current delay component remains.

Estimating the current delay component based on the mean value (S630). The above-described procedure is performed under the previously set current application condition so that the processor may stably deduce the current delay component while effectively removing the influence caused by the sensor offset.

In the exemplary embodiment, the processor deduces the offset error of the rotor position sensor based on the difference between the current delay components determined so as to correspond to the forward driving and the backward driving.

To be more specific, the current delay component determined during the forward driving may include a sensor offset influence in a positive (+) direction and the current delay component determined during the backward driving may include the same offset influence in a negative (−) direction. Accordingly, if the difference of two results is analyzed, a pattern to which the sensor offsets are symmetrically reflected may be deduced and the processor may quantitively determine the magnitude and the direction of the offset error based thereon.

For example, if the current delay component determined by the forward driving under a specific rotation speed condition is deviated by +Δ (deviation value) and the current delay component determined by the backward driving is deviated by −Δ, under a specific rotation speed condition, the processor may deduce an offset error corresponding to 2Δ by determining a difference between two values. At this time, Δ may be a value which reflects a regular deviation caused by a sensor signal processing delay, an installation angle error, or an environmental influence.

That is, the processor may identify a sensor offset error while estimating a current delay component so that the sensor reliability may be ensured without a separate sensor calibration procedure or an additional hardware correction device. Further, the method of considering both forward and backward driving data may suppress error analysis biased to a specific direction so that a consistent correction effect may be provided under various operation conditions. In other words, the processor stably estimates the current delay component and precisely deduces the sensor offset error, thereby improving a control performance and a safety of the entire system.

In various exemplary embodiments, if the estimated current delay component is deviated from a previously defined effective range, the processor may generate an error diagnosis signal. To be more specific, the processor may previously define an effective range of a current delay component under a normal operation condition and if the estimated current delay component exceeds a defined effective range, determines that the abnormality occurs in an algorithm execution process. For example, if the estimated current delay component is excessively larger than the sampling cycle or is determined as a negative value, it may mean a computation error, data processing inconsistency, or failure of convergence of a regression analysis process in the current delay component estimation algorithm. The processor determines the above-described situation as an error of its own estimation algorithm and generates an error diagnosis signal to transmit the error diagnosis signal to a diagnosis module or an upper-level controller. The generated error diagnosis signal induces a subsequent procedure, such as algorithm re-initialization, correction routine re-execution, or safe mode switch to ensure the stability and the reliability of the system.

According to the exemplary embodiment, the processor may generate the delay compensation control signal to correct the inconsistency between the current sampling timing and the rotor position detection timing based on the estimated current delay component.

Specifically, the processor corrects the current sampling timing or adjusts a reference value of the rotor position detection timing based on the estimated current delay component to determine a control signal which minimizes the inconsistency between two timings. For example, if the current delay component is determined in the unit of specific cycles, the processor inserts a correction delay time as much as the corresponding period or corrects a phase of the position detection signal to synchronize a current control loop and a position detection loop. That is, the delay compensation control signal aligns a time axis of the current sampling and the position detection to improve a precision of the torque control and specifically, may ensure the stable motor control performance under a high-speed driving condition or a sharp load change condition.

In summary, the current delay component estimation apparatus of the present disclosure changes the current delay correction variable to a plurality of values and may acquire torque response data thereby. Further, the current delay component estimation apparatus may linearly organize a relationship between the current delay correction variable and the torque response data, thereby estimating a current delay component. Further, the current delay component estimation apparatus removes a friction torque measured in an open state of the inverter switching element from the torque response data to exclude an error caused by the friction. Further, the current delay component estimation apparatus determines a current delay component by considering both forward and backward driving of the electric motor to deduce an offset error of the rotor position sensor and confirms a sensor correction state. Additionally, if the estimated current delay component is not effectively determined in a previously defined range, the current delay component estimation apparatus processes it as an error of a sensing algorithm. Accordingly, the current delay component estimation apparatus according to the present disclosure may be reliably applied under various operation conditions and improves the accuracy and the stability of the motor control.

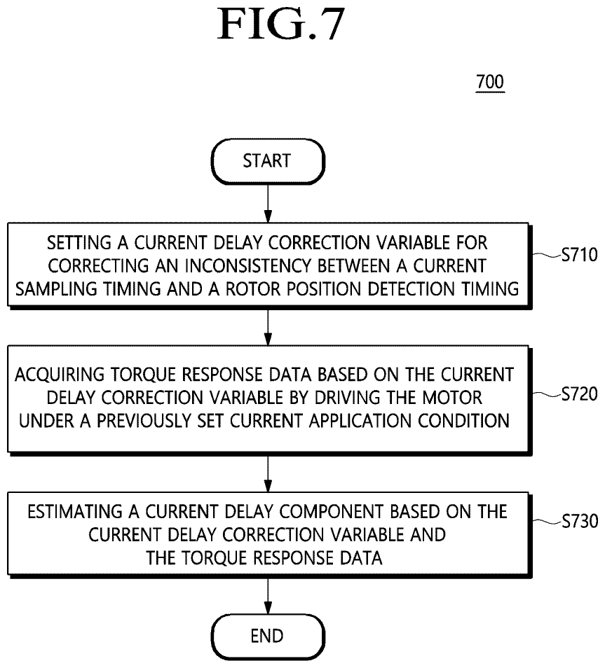

FIG. 7 is an exemplary flowchart illustrating a current delay component estimation method 700 according to an exemplary embodiment of the present disclosure. Steps illustrated in FIG. 7 may be reordered as needed and at least one step may be omitted or added. Steps of FIG. 7 are merely an exemplary embodiment of the present disclosure and the scope of the present disclosure is not limited thereby. Among the features illustrated in FIG. 7, features that overlap the features which have been described above with regard to FIGS. 1 to 6 may refer to the description in FIGS. 1 to 6, and the description thereof will be omitted herein.

According to an exemplary embodiment of the present disclosure, the current delay component estimation method may include setting a current delay correction variable for correcting an inconsistency between a current sampling timing and a rotor position detection timing (S710).

In the exemplary embodiment, the current delay correction variable may be set to a plurality of different values within a previously defined range, based on a time unit corresponding to the sampling period.

According to the exemplary embodiment of the present disclosure, the current delay component estimation method may include acquiring torque response data based on the current delay correction variable by driving the motor under a previously set current application condition (S720).

In one exemplary embodiment, the previously set current application condition may be a current application condition in which a q-axis current is maintained as 0 and only a d-axis current is applied.

Further, in the exemplary embodiment, the acquiring of torque response data may include changing a current delay correction variable to a plurality of candidate values, acquiring a plurality of torque response data so as to correspond to each of the plurality of candidate values, and generating a torque response data set by matching the plurality of torque response data and corresponding current delay correction variable values.

According to the exemplary embodiment of the present disclosure, the current delay component estimation method may include estimating a current delay component based on the current delay correction variable and the torque response data (S730).

Further, in the exemplary embodiment, the estimating of a current delay component includes determining a linear regression function based on a torque response data set, deducing a torque zero-crossing point at which a torque value becomes 0 from the linear regression function, and determining a value of the current delay correction variable at the torque zero-crossing point as a current delay component.

Further, in the exemplary embodiment, the estimating of a current delay component may include generating a control signal to open an inverter switching element of the electric motor and acquiring a friction torque so as to correspond to an open state of the switching element, generating friction-corrected torque response data by removing the measured friction torque from torque response data, and estimating a current delay component based on the friction-corrected torque response data.

Further, in the exemplary embodiment, the estimating of a current delay component may include generating a driving control signal for forward and backward driving of an electric motor, determining a mean value between the current delay components determined so as to correspond to the forward and backward driving, and estimating a current delay component based on the mean value.

In the exemplary embodiment, the estimating of a current delay component may include deducing the offset error of the rotor position sensor based on the difference between the current delay components determined so as to correspond to the forward driving and the backward driving.

In various exemplary embodiments, the current delay component estimation method further includes generating a delay compensation control signal to correct inconsistency between the current sampling timing and the rotor position detection timing based on the estimated current delay component.

In various exemplary embodiments, the current delay component estimation method may further include generating an error diagnosis signal if the estimated current delay component deviates from the previously defined effective range.

A vehicle control system according to another exemplary embodiment of the present disclosure may include a steering control device which controls steering of a vehicle, an electric motor which generates a steering torque to drive the steering control device, and a current delay component estimation apparatus which estimates a current delay component according to an operation of the electric motor.

The components included in the above-described vehicle control system are just examples for better understanding and the present disclosure is not limited thereto. For example, the vehicle control system may further include an additional component, such as a power management device, a power distribution device, a battery management system (BMS), or a communication module. For example, the power management device monitors a charging/discharging state of the battery and controls power supply to an inverter and the communication module is linked to an in-vehicle network (CAN, LIN, Ethernet, or the like.) or an external infra to exchange signals between the traveling control device and the motor control device.

Further, according to an exemplary embodiment, specific components may be omitted or functionally combined. For example, the traveling control device and the motor control device are implemented as one electric control unit ECU and a current sensor or a gate driver circuit is included in a multi-phase inverter so as not to be provided as a separate configuration.

In one exemplary embodiment, the steering control device comprehensively determines a vehicle operation state and a traveling environment to control a traveling operation, such as acceleration, deceleration, steering, and braking. The steering control device collects data from an external vehicle sensor (for example, a camera, a radar, or LiDAR) and an internal sensor (for example, a velocity sensor, a yaw rate sensor, and an acceleration sensor) to recognize a traveling situation and generates a control signal for vehicle stability ensuring, path following, steering convenience improvement based thereon. The steering control device interworks with the steering motor control device to determine a demand steering torque and a control input of the vehicle and performs cooperation control with a vehicle dynamic control system as needed.

Further, in one exemplary embodiment, an electric motor which generates a steering torque is a driving source required for vehicle steering and is driven according to voltage and current signals applied from the inverter. The electric motor provides an output required for various steering modes and specifically is driven under a previously set current application condition in which a q-axis current is maintained as 0 and only a d-axis current is applied. This condition is utilized as a reference environment for precisely determining a delay component in the current delay component estimation apparatus. Further, the electric motor may be operated in a diagnosis mode to verify a sensor and a controller in a zero-torque state and during this process, the current delay component is estimated to contribute to improvement of the accuracy of the controller.

Further, the current delay component estimation apparatus sets a current delay correction variable to correct inconsistency between a current sampling timing and a rotor position detection timing, acquires torque response data according to a current delay correction variable so as to correspond to a driving state of the electric motor under a previously set current application condition, and estimates a current delay component based on the current delay correction variable and the torque response data. Specifically, the current delay component estimation apparatus configures a torque response data set according to a plurality of current delay correction variable values and determines a linear regression function based on the configured torque response data set to deduce a torque zero-crossing point, thereby precisely estimating an actual current delay component. Further, the influence of the mechanical load or the sensor offset error may be excluded by an averaging computation utilizing a friction torque removal procedure or a forward/backward driving condition, thereby stably and reliably estimating a current delay component under various operation conditions. Additionally, the current delay component estimation apparatus generates an error diagnosis signal or generates a delay compensation control signal to be applied in real time if the estimated current delay component is deviated from the effective range, thereby improving a control performance and the safety of the entire vehicle control system.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. An apparatus for controlling a motor, the apparatus comprising:
memory configured to store instructions; and
at least one processor configured to execute one or more of the instructions to perform operations comprising:
setting a current delay correction variable for correcting an inconsistency between a current sampling timing and a rotor position detection timing;
acquiring torque response data based on the current delay correction variable by driving the motor under a previously set current application condition;
estimating a current delay component based on the current delay correction variable and the torque response data; and
controlling the motor based on the current delay component estimated based on the current delay correction variable and the torque response data.

2. The apparatus according to claim 1, wherein the previously set current application condition comprises a current application condition in which a quadrature-axis current is maintained as zero (0) and only a direct-axis current is applied to the motor and the direct-axis current is set based on one of a maximum current value of an inverter of the motor or a current source component value of a permanent magnet of the motor.

3. The apparatus according to claim 1, wherein the current delay correction variable is set to a plurality of candidate values to have different time delay values in a sampling period.

4. The apparatus according to claim 3, wherein:
the acquiring of the torque response data comprises acquiring a plurality of torque response data based on the plurality of candidate values, and generating a torque response data set by matching the plurality of torque response data and current delay correction variable values, respectively, and
the estmating of the current delay component comprises determining a linear regression function based on the torque response data set, deducing a torque zero-crossing point at which a torque value becomes zero (0) from the linear regression function, and estimating a current delay correction variable value at the torque zero-crossing point as the current delay component.

5. The apparatus according to claim 1, wherein the estimating of the current delay component comprises generating a control signal to open a switch of an inverter of the motor, acquiring a friction torque corresponding to an open state of the switch of the inverter, generating friction-corrected torque response data by removing the acquired friction torque from the torque response data, and estimating the current delay component based on the friction-corrected torque response data.

6. The apparatus according to claim 1, wherein the estimating of the current delay component comprises generating a driving control signal for forward or backward driving of the motor, determining a mean value derived from current delay components determined to correspond to the forward and backward driving of the motor, and estimating the current delay component based on the mean value.

7. The apparatus according to claim 6, wherein the estimating of the current delay component comprises deducing an offset error of a rotor position sensor based on difference between the current delay components determined to correspond to the forward and backward driving of the motor.

8. The apparatus according to claim 1, wherein the operations further comprise generating a delay compensation control signal to correct the inconsistency between the current sampling timing and the rotor position detection timing based on the estimated current delay component.

9. The apparatus according to claim 1, wherein the processor is configured to, if the estimated current delay component is deviated from a previously defined effective range, generate an error diagnosis signal.

10. A method for controlling a motor, the method comprising:
setting a current delay correction variable for correcting an inconsistency between a current sampling timing and a rotor position detection timing;
acquiring torque response data based on the current delay correction variable by driving the motor under a previously set current application condition;
estimating a current delay component based on the current delay correction variable and the torque response data; and
controlling the motor based on the current delay component estimated based on the current delay correction variable and the torque response data.

11. The method according to claim 10, wherein the previously set current application condition comprises a current application condition in which a quadrature-axis current is maintained as zero (0) and only a direct-axis current is applied to the motor and the direct-axis current is set based on one of a maximum current value of an inverter of the motor or a current source component value of a permanent magnet of the motor.

12. The method according to claim 10, wherein the current delay correction variable is set to a plurality of candidate values to have different time delay values in a sampling period.

13. The method according to claim 12, wherein the acquiring of the torque response data includes:
acquiring a plurality of torque response data based on the plurality of candidate values; and
generating a torque response data set by matching the plurality of torque response data and current delay correction variable values, respectively.

14. The method according to claim 13, wherein the estimating of the current delay component includes:
determining a linear regression function based on the torque response data set;
deducing a torque zero-crossing point at which a torque value from the linear regression function becomes zero (0) using the linear regression function; and
estimating a current delay correction variable at the torque zero-crossing point as the current delay component.

15. The method according to claim 10, wherein the estimating of the current delay component includes:
generating a control signal to open a switch of an inverter of the motor and acquiring a friction torque corresponding to an open state of the switch of the inventor;
generating friction-corrected torque response data by removing the acquired friction torque from the torque response data; and
estimating the current delay component based on the friction-corrected torque response data.

16. The method according to claim 10, wherein the estimating of the current delay component includes:
generating a driving control signal for forward or backward driving of the motor;
determining a mean value derived from current delay components determined to correspond to the forward and backward driving of the motor; and
estimating the current delay component based on the mean value.

17. The method according to claim 16, wherein the estimating of the current delay component includes:
deducing an offset error of a rotor position sensor based on difference between the current delay components determined to correspond to the forward and the backward driving of the motor.

18. The method according to claim 10, further comprising:
generating a delay compensation control signal for correcting the inconsistency between the current sampling timing and the rotor position detection timing based on the estimated current delay component.

19. The method according to claim 10, further comprising:
generating an error diagnosis signal if the estimated current delay component is deviated from a previously defined effective range.

20. A vehicle control system, comprising:
a steering controller configured to control steering of a vehicle;
a motor configured to generate a steering torque for an operatio associated with the steering of the vehicle; and
at least one processor configured to:
set a current delay correction variable for correcting an inconsistency between a current sampling timing and a rotor position detection timing;
acquiring torque response data based on the current delay correction variable by driving the motor under a previously set current application condition;
estimating a current delay component based on the current delay correction variable and the torque response data; and
controlling the motor based on the current delay component estimated based on the current delay correction variable and the torque response data.
